(19) United States
(12) Patent Application Publication
(10) Pub. No.: US 2011/0223509 A1
(43) Pub. Date: Sep. 15, 2011

(54) High Temperature Fuel Cell and Associated Fuel Cell Assembly

(76) Inventors: Horst Greiner, Forchheim (DE); Alessandro Zampieri, Erlangen (DE)

(21) Appl. No.: 13/121,778

(22) PCT Filed: Sep. 22, 2009
(86) PCT No.: PCT/EP2009/062236

§ 371 Date: Jun. 2, 2011

(30) Foreign Application Priority Data
Sep. 30, 2008 (DE) 10 2008 049 607.3

(51) Int. Cl. H01M 4/66; H01M 4/90; H01M 8/24

(52) U.S. Cl. 429/452; 429/532; 429/527

(57) ABSTRACT

A high temperature fuel cell and a fuel cell assembly comprising a plurality of fuel cells are provided. The fuel cells operate at a temperature between 500 and 700° C. Copper-based materials for components and connections of the components is used in the fuel cells. A basis for the copper-based materials is an ODS (Oxide Dispersion Strengthened) structure of copper powders with additional oxide powders.

### CROSS REFERENCE TO RELATED APPLICATIONS

This application is the US National Stage of International Application No. PCT/EP2009/062236 filed Sep. 22, 2009, and claims the benefit thereof. The International Application claims the benefits of German Application No. 10 2008 049 607.3 DE filed Sep. 30, 2008. All of the applications are incorporated by reference herein in their entirety.

### FIELD OF INVENTION

The invention relates to a high temperature fuel cell (SOFC). In addition, the invention relates to an associated fuel cell system made up of such fuel cells. In particular, the invention relates to the use of copper for the anodes in the individual fuel cells and as cell connectors or rather contacting elements in the fuel cell system as a whole.

### BACKGROUND OF INVENTION

The costs of solid electrolyte fuel cells (SOFC=Solid Oxide Fuel Cell) already known from the prior art must be reduced if they are to enter practical use. A possible way of reducing costs for high temperature fuel cells is to replace the nickel (Ni) used in the anodes and in the cell connectors by better conducting and less expensive copper (Cu).

It is not possible to use Cu in high temperature (HT) SOFC generators operated at temperatures between 900 and 1000° C. Copper, which has a much lower melting point than nickel, generally tends to exhibit non-negligible material transport even at relatively low operating temperatures. Such transport phenomena can be diffusion, electrotransport and/or thermotransport. However, this adversely affects the long-term stability of copper-based SOFC anodes.

Copper also has a tendency to react with nickel even at relatively low temperatures and, in particular, to form alloys (see copper-nickel phase diagram, Hansen/Anderko “Constitution of Binary Alloys” (McGraw-Hill 1958), page 602). For that reason, if copper is used in an SOFC generator, all the nickel components must always be replaced by copper components.

Particularly when using copper-based materials to reduce the operating temperature in fuel cells, it is imperative that the anode also be based on copper. This applies to the SOFCs of different designs, particularly also the tubular, HPD or Δ-cells.

In addition, it must be ensured that the cell-to-cell connector materials, such as pastes or tapes for the implementation thereof, are likewise copper-based. The copper-based pastes or more rather slips for the implementation thereof, and also tapes must be conductive, porous and stable at the operating temperature of the generator, and this for comparatively long operating times.

It is also known from the prior art that particularly copper anodes have a tendency to grain coarsening and sintering at comparatively low temperatures, i.e. at 600 to 700° C. This behavior reduces the useful life and calls into question the applicability of the copper-based pastes and anodes. It is also observed that the porous layers become denser over time, thereby reducing the active specific surface area (three-phase boundaries) of the anode.

It is observed that the contact pastes or the anodes become denser in the corresponding time period and that the porosity of the materials diminishes if copper grains in the slip sinter together and form larger agglomerates, and this in a relatively short time even at relatively low temperatures (600-700° C.). The diffusion resistance in the anode therefore increases and cell performance deteriorates over time.

### SUMMARY OF INVENTION

An object of the invention is to propose copper-based materials, and corresponding methods for the production thereof, which can be used in SOFC anodes and also as adhesive pastes in the fuel cell system. Said materials shall in particular have increased stability at higher operating temperatures.

The object is achieved by a fuel cell and by a fuel cell system as claimed in the independent claims. Further developments are detailed in the respective sub-claims.

The subject matter of the invention is the selection of such copper-based materials for the individual fuel cells—both for the anode and for the materials for connection to the contacting elements—wherein a mechanical alloy of so-called ODS copper powders with fine oxide powders is present i.e. as a dispersion alloy (ODS: Oxide Dispersion Strengthened). In particular, according to the invention, the ODS Cu/metal oxide material is produced by mechanical alloying of the different powders.

In the invention it is taken into account that copper-based anodes on the one hand and mechanical alloying on the other are already known from the prior art. The essential aspect is to produce the copper-based materials by mechanical alloying in such a way that no separation phenomena occur.

The invention advantageously proposes novel copper-based materials of this kind for fuel cells, such as anode layer and anode contact paste, which can advantageously operate at lower temperatures, in particular in the range 400-700° C., or even at medium working temperatures, in particular in the range 700-950° C., said materials being used for the anodes and also for all the other connections. Instead of increasing the thermal stability of copper in the slip by chemical alloying with other metals such as nickel or cobalt, as is done in the prior art (as cited), the invention proposes the use of copper particles with ultra-fine distributions of particular metal oxides by mechanical alloying.

The distribution of metal oxide particles allows better thermal stability of the copper particles, as has been demonstrated experimentally, and results in a longer operating life and a slower degradation rate of the contact slip.

The invention is based on the recognition that excessive sintering between copper particles, particularly in the anode and contact paste, is avoided and that densification of the contact pastes in the individual bundles of fuel cells and therefore in the generator as a whole can then also be eliminated. The performance, i.e. the long-term stability, of the novel fuel cells should be improved as a result.

It is therefore essential to ensure that the anodes and the contacts between the cells in the stack and between the individual stacks in the fuel cell system are copper.

Advantageously, the already mentioned ODS copper/metal oxide powders, i.e. Cu/doped ZrO₂—such as Cu/YSZ or Cu/ScSZ—or Cu/doped CeO₂—such as Cu/GDC or Cu/SDC—for example, can be used as layers or paste for the above purpose. In principle, all conceivable Cu/metal oxide combinations with different dispersion material content and grain size can be used. In order to optimize the material properties, the oxide dispersion must be present with good distribution in the sub-micrometer range, e.g. also in the nano range. All the metal oxides are substitutable, but in particular the oxides of the electrolyte material, in order to avoid any reactions between the different elements over long-term operation of the fuel cell system.

As an advantageous mechanism of the invention it was recognized that the dispersion energetically blocks the movement of copper in order to minimize the specific surface area.

The anode layers can be produced using wet coating methods such as roller coating, screen printing, wet powder spraying, and by additional sintering processes. The anode paste or solution/suspension consists of ODS copper powder, electrolyte material, water, binding agent, plasticizer, and possibly a porous material, e.g. graphite or polymeric materials.

Individual copper-based anodes or multilayer arrangements, one of which is ODS Cu powder based, can be implemented. The contact paste (this could possibly be in the form of adhesive tape) consists of the ODS copper powder, water, binding agent or adhesive materials, e.g. polyvinyl acetate (PVA) where necessary mixed with a plasticizer in order to control the viscosity. Other additives are also possible.

Further details and advantages of the invention will emerge from the following description of examples which proceeds with reference to the accompanying drawings and in conjunction with the relevant claims.

### BRIEF DESCRIPTION OF THE DRAWINGS

FIG. 1 shows a micrograph of pure copper powder,

FIG. 2 shows a micrograph of sintered Cu/SCZ material and

FIG. 3 schematically illustrates copper particles with ultra-finely distributed metal oxides mechanically alloyed therewith.

### DETAILED DESCRIPTION OF INVENTION

The figures will now be described essentially collectively. Examined and described below are essentially the compatibility and the properties of contact materials or more specifically contact pastes based on copper particles which are mechanically alloyed in particular with ScSZ.

In general, the latter concept for achieving thermally stable copper-based anodes and contacts for fuel cells with low or medium temperatures can also be extended to copper powders with other metal oxides, provided mechanical alloying takes place. It was known that the use of such ODS powders, i.e. copper powders with metal oxide powders which are combined by mechanical alloying, results in improved characteristics in SOFC fuel cells. This applies both to tubular fuel cells, HPD fuel cells or even Δ-cells in which the fuel cell system consists of a cell bundle. However, even for planar fuel cell systems with layered stacks, copper/metal oxide based pastes can be used as contacting elements and also as the basis for the anodes.

The production of such functional layers with ODS powders can take place by applying corresponding materials e.g. by liquid spraying, by mechanical deposition or by preparation via tapes. In order to increase the sinterability of the copper particles in the liquid or paste, copper powders can be mixed together with copper/metal oxides already produced by mechanical alloying.

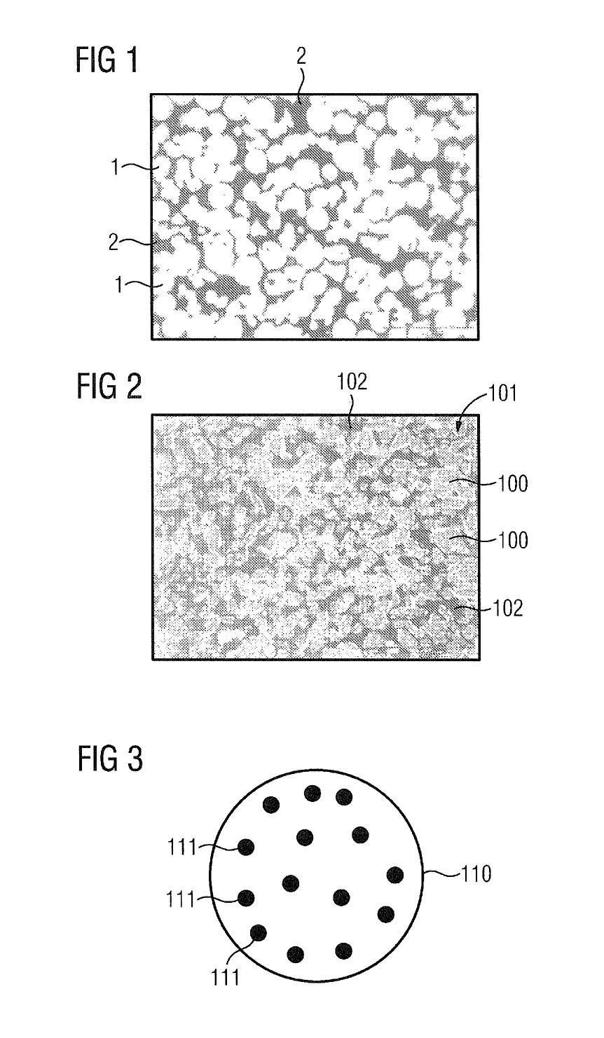

In FIG. 1, the copper particles are denoted by 1, as they occur in bed of copper powder. Pores 2 are visibly present.

In contrast, FIG. 2 shows a composite material of Cu/SCSZ 10 mol % after heat treatment at 1000° for 125 h. It can clearly be seen that the pure copper powder has sintered together into larger regions 10 and forms extended agglomerates corresponding to FIG. 1, while the Cu/ScSZ powder is characterized by a few contact connections under the particles 10. These contact connections provide the electrical conductivity to form a network in the anode which permits electronic conductivity. Otherwise, the individual particles appear as discrete regions and essentially unchanged compared to FIG. 1.

FIG. 3 shows a particle 110 produced by mechanical alloying. For the production process and technology of mechanical alloying, reference is made to the relevant technical literature. As a process product, a distribution of essentially smaller metal oxide particles 111 is produced in the larger particle 110 from a copper matrix according to FIG. 1. For example, the copper oxide particles 111 have a diameter of 100 nm, the matrix particles possibly measuring 1 mm or more. This produces according to FIG. 2 a statistical distribution of the metal oxide particles 111 in the matrix 110.

The formation of the fine oxide particles, e.g. based on the ScSZ powders described in the figures, can extend from the micrometer range to the sub-micron range. For example, an average diameter distribution of d₅₀=100 nm may be present. The high-temperature stability of copper is therefore increased and the mobility during sintering reduced. In some cases, particle distributions of the metal oxides into the lower nano range can occur, with similar results also being likely.

The anodes of SOFC fuel cells are constructed using the hybrid particles of copper with mechanically alloyed ODS copper/oxide particles as described in FIGS. 1 to 3. In addition, the material for the contacting elements can be produced on this basis, thereby solving the problem of the copper separating out in the course of long-term operation of the novel fuel cells. As mentioned in the introduction, it is assumed that mechanical alloying to improve material structures is known per se. However, mechanical alloying has not yet been mentioned in connection with high temperature fuel cells and providing the parts or material therefor.

In conclusion, it is held that the ODS dispersion of metal oxide in metal grains is suitable for replacing the previous nickel-based anode in high temperature fuel cells, provided that the operating temperature is reduced in the fuel cell system. The corresponding connections in paste-like or liquid consistency for the purpose of contacting the individual parts of the fuel cell system can also have corresponding copper/copper oxide based ODS materials. The use of pastes with copper/metal oxide distributions allows improved thermal stability and a longer operating life of the SOFC and of the individual fuel cells or rather of the fuel cell bundles. This results in a significant cost reduction for the known SOFC generators, which is highly relevant for practical applications.

Altogether the materials described are used in fuel cells wherein the anode has a thickness of approximately 1 to 100 μm. The ODS copper powder based layer can be used here as a current collector layer in a multilayer anode structure. The anode can be infiltrated with additional precursor suspensions—e.g. CeO₂, Co, Ni—using wet chemical or CVD processes, for example, in order to increase the electrochemical activity. The metal oxide based particles are of an order of magnitude <1 μm and can be in particular in the nano range, i.e. submicrometer range. Specifically, the ODS material can be constituted by Cu/ZrO₂ or Cu/doped ZrO₂, such as Cu/YSZ or Cu/ScSZ, for example. The ODS can also be constituted by Cu/doped CeO₂, such as Cu/GDC or Cu/SDC or Cu/GDC, for example.

In an associated fuel cell system consisting of such fuel cells which form stacks or bundles interconnected in an electrically conducting manner via contacting elements, pastes or other starting materials for contact-making between cells and cell connectors are formed using the mechanically alloyed powders, said cell connectors being, for example, foams, wires, networks, hollow cords or similar knotted fabrics.

1.-12. (canceled)

13. A high temperature fuel cell operating in a temperature range from 400 to 900° C., comprising:
copper-based materials for components and connections of the components, wherein a basis for the copper-based materials is an ODS (Oxide Dispersion Strengthened) structure of copper powders with additional oxide powders.

14. The fuel cell as claimed in claim 13, wherein the fuel cell operates at a temperature between 500 and 700° C.

15. The fuel cell as claimed in claim 13, wherein the ODS structure consisting of copper powders with additional oxide powder dispersions is produced by mechanical alloying of the powders.

16. The fuel cell as claimed in claim 15, wherein the ODS structure produced by mechanical alloying is used to form an anode as a functional layer.

17. The fuel cell as claimed in claim 16, wherein the anode has a thickness of approximately 1 to 100 μm.

18. The fuel cell as claimed in claim 13, wherein the ODS copper powder based layer is used as a current collector layer and forms a multilayer anode structure.

19. The fuel cell as claimed in claim 16, wherein the anode is infiltrated with additional precursor suspensions in order to increase the electrochemical activity.

20. The fuel cell as claimed in claim 19, wherein the additional precursor suspensions are CeO2 and/or Co and/or Ni.

21. The fuel cell as claimed in claim 15, wherein metal oxide based particles in the ODS structure produced by mechanical alloying are of an order of magnitude <1 μm.

22. The fuel cell as claimed in claim 21, wherein the metal oxide particles are of an order of magnitude in the nano range.

23. The fuel cell as claimed in claim 13, wherein the ODS structure is formed from Cu/ZrO2.

24. The fuel cell as claimed in claim 13, wherein the ODS structure is formed form Cu/doped ZrO2, such as Cu/YSZ or Cu/ScSZ.

25. The fuel cell as claimed in claim 13, wherein the ODS structure is formed from Cu/doped CeO2, such as Cu/GDC or Cu/SDC.

26. A high temperature fuel cell assembly, comprising:
a plurality of fuel cells, each fuel cell comprising copper-based materials for components and connections of the components, wherein a basis for the copper-based materials is an ODS (Oxide Dispersion Strengthened) structure of copper powders with additional oxide powders,
wherein the fuel cells form stacks or bundles which are interconnected in an electrically conducting manner by contacting elements, and
wherein mechanically alloyed powders are used to form pastes or other starting materials for contact-making between cells and cell connectors.

27. The fuel cell assembly as claimed in claim 26, wherein the cell connectors are foams, wires, networks, hollow cords or the like.
